(19) United States
(12) Patent Application Publication
(10) Pub. No.: US 2009/0091264 A1
(43) Pub. Date: Apr. 9, 2009

(54) PIXEL CIRCUIT

(75) Inventor: Yu-Wen Chiou, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Tainan County (TW)

(21) Appl. No.: 11/867,314

(22) Filed: Oct. 4, 2007

(51) Int. Cl. G09G 3/10

(52) U.S. Cl. 315/169.1

(57) ABSTRACT

A pixel circuit has a light emitting diode, a first switch, a driving transistor, a capacitor, and a second switch. The first switch has a first end coupled to the light emitting diode, wherein the first switch is controlled by a first scan signal. The driving transistor has source/drains respectively coupling to a first power source terminal and a second end of the first switch. The capacitor couples between a gate of the driving transistor and a second power source terminal. The second switch respectively couples the second end of the first switch to the capacitor, and couples the gate and the source/drain of the driving transistor together when a second scan signal is asserted.

### BACKGROUND

1. Field of Invention

The present invention relates to a pixel circuit, and more particularly relates to an LED voltage type compensation pixel circuit.

2. Description of Related Art

FIG. 1 shows an organic light emitting diode pixel circuit of the prior art. The pixel circuit is a voltage type compensation pixel circuit. The pixel circuit has an organic light emitting diode 180, a first transistor 170, a driving transistor 130, a capacitor 150, and a second transistor 110. The first transistor 170 has a source/drain 176 coupled to the light emitting diode 180, wherein the first transistor 170 is controlled by a first scan signal. The driving transistor 130 has source/drains 132 and 136. The source/drain 132 couples to a power source terminal 140 through the transistor 160, and the source/drain 136 couples to a source/drain 172 of the first transistor 170. The capacitor 150 couples a gate 134 of the driving transistor 130 and the power source terminal 140. When a second scan signal is asserted, the second transistor 110 respectively couples the source/drain 172 of the first transistor 170 to the capacitor 150, and couples the gate 134 and the source/drain 136 of the driving transistor 130 together.

Otherwise, when the second scan signal is asserted, the transistor 160 is turned off; when the second scan signal is de-asserted, the transistor 160 is turned on. The pixel circuit also has a third transistor 190 controlled by the second scan signal to couple a data line 120 and the source/drain 132 of the driving transistor 130.

The drawback of the conventional pixel circuit is that it has five transistors (transistors 110, 130, 160, 170 and 190). These transistors reduce the aperture ratio of the pixel circuit.

### SUMMARY

According to one embodiment of the present invention, the pixel circuit has a light emitting diode, a first switch, a driving transistor, a capacitor, and a second switch. The first switch has a first end coupled to the light emitting diode, wherein the first switch is controlled by a first scan signal. The driving transistor has source/drains respectively coupling to a first power source terminal and a second end of the first switch. The capacitor couples a gate of the driving transistor and a second power source terminal. The second switch respectively couples the second end of the first switch to the capacitor, and couples the gate and the source/drain of the driving transistor together when a second scan signal is asserted.

According to another embodiment of the present invention, a pixel circuit has a driving transistor, a light emitting diode and a capacitor. The light emitting diode has a cathode coupled to a first power terminal. The capacitor is coupled between a gate of the driving transistor and a second power source terminal. A first source/drain of the driving transistor is coupled to an anode of the light emitting diode and a second source/drain of the driving transistor is coupled to receive a data signal during a precharge period. The first source/drain of the driving transistor is decoupled from the anode of the light emitting diode and the second source/drain of the driving transistor is coupled to receive the data signal during a programming period. The first source/drain of the driving transistor is coupled to the anode of the light emitting diode and the second source/drain of the driving transistor is coupled to the second power terminal during a display period.

According to another embodiment of the present invention, the pixel circuit has an organic light emitting diode, a first switch, a driving transistor, a capacitor, and a switch unit. The first switch has a first end coupled to the light emitting diode, wherein the first switch is controlled by a first scan signal. The driving transistor has a source/drain coupling to a second end of the first switch. The capacitor couples between a gate of the driving transistor and a power source terminal. The switch unit respectively couples the second end of the first switch to the capacitor, couples the gate and the source/drain of the driving transistor together, and couples a source/drain of the driving transistor to the power source terminal when a second scan signal is asserted.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows an organic light emitting diode pixel circuit of the prior art;

FIG. 2A shows an organic light emitting diode pixel circuit according to an embodiment of the invention;

FIG. 2B shows the waveform diagrams of the signals of the embodiment shown in FIG. 2A;

FIG. 3A shows the organic light emitting diode pixel circuit during a precharge stage according to the embodiment of the invention;

FIG. 3B shows the organic light emitting diode pixel circuit during a programming stage according to the embodiment of the invention;

FIG. 3C shows the organic light emitting diode pixel circuit during a display stage according to the embodiment of the invention; and

FIG. 4A shows an organic light emitting diode pixel circuit according to another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

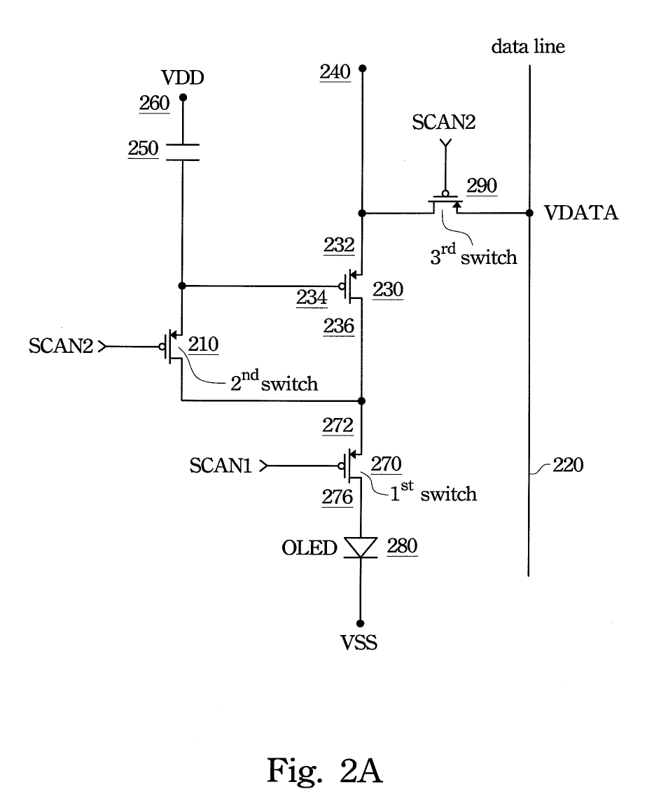

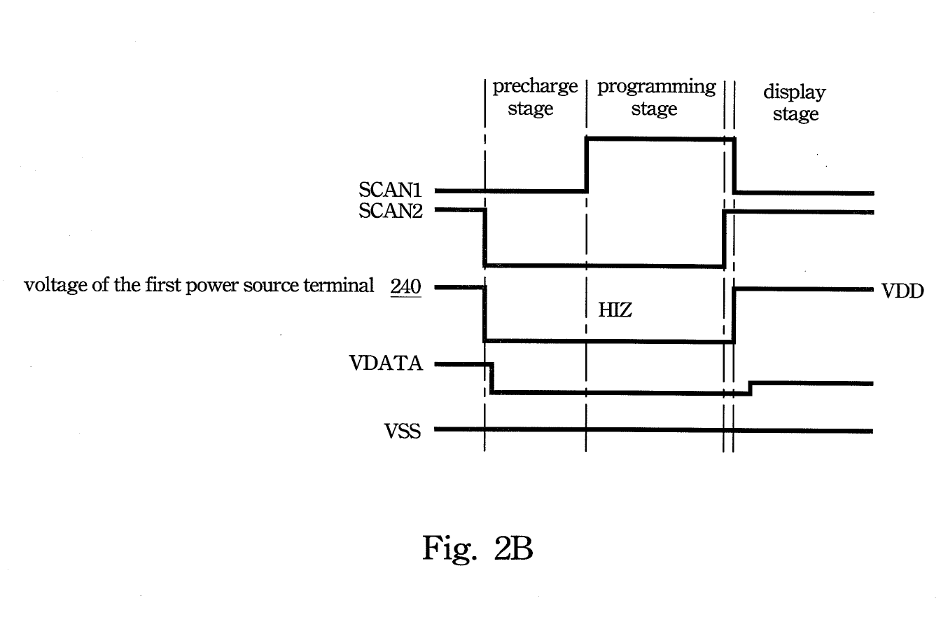

FIG. 2A shows an organic light emitting diode pixel circuit according to an embodiment of the invention. The pixel circuit is a voltage type compensation pixel circuit. The pixel circuit has a light emitting diode, e.g. an organic light emitting diode 280, a first switch 270, a driving transistor 230, a capacitor 250, and a second switch 210. The first switch 270 has a first end 276 coupled to the light emitting diode 280, wherein the first switch 270 is controlled by a first scan signal (SCAN1). The driving transistor 230 has source/drains 232 and 236 respectively coupling to a first power source terminal 240 and a second end 272 of the first switch 270. The capacitor 250 couples a gate 234 of the driving transistor 230 and a second power source terminal 260. The second switch 210 respectively couples the second end 272 of the first switch 270 to the capacitor 250, and couples the gate 234 and the source/drain 236 of the driving transistor 230 together when a second scan signal (SCAN2) is asserted.

The pixel circuit has a third switch 290 controlled by the second scan signal to couple between a data line 220 and the source/drain 232 of the driving transistor 230. Therefore, when the second scan signal is asserted, the data signals from the data line 220 are transmitted to the pixel circuit.

FIG. 2B shows the waveform diagrams of the signals of the embodiment shown in FIG. 2A. The voltages of the first power source terminal 240 and the second power source terminal 260 are provided by a gate driver. The first scan signal turns on the first switch 270 during a precharge stage and a display stage, and turns off the first switch 270 during a programming stage. The second scan signal turns on the second switch 210 during the precharge and programming stages, and turns off the second switch 210 during the display stage.

The first power source terminal 240 is floating (HIZ, high impedance) when the third switch is turned on (i.e. during the precharge and programming stages), and the voltage of the second power source terminal 260 is a fixed voltage. Therefore, the data signals can be written into the pixel circuit more easily during the precharge and programming stages. Otherwise, from the description above, the pixel circuit doesn't need an extra reset signal to make the writing the data signals written easy.

The first switch 270, the second switch 210 and the third switch 290 can be implemented by transistors. In this embodiment shown in the FIG. 2A, the switches 270, 210 and 290 are PMOS transistors. If the switches 270, 210 and 290 are configured by NMOS transistors, the control signals have to be inversed.

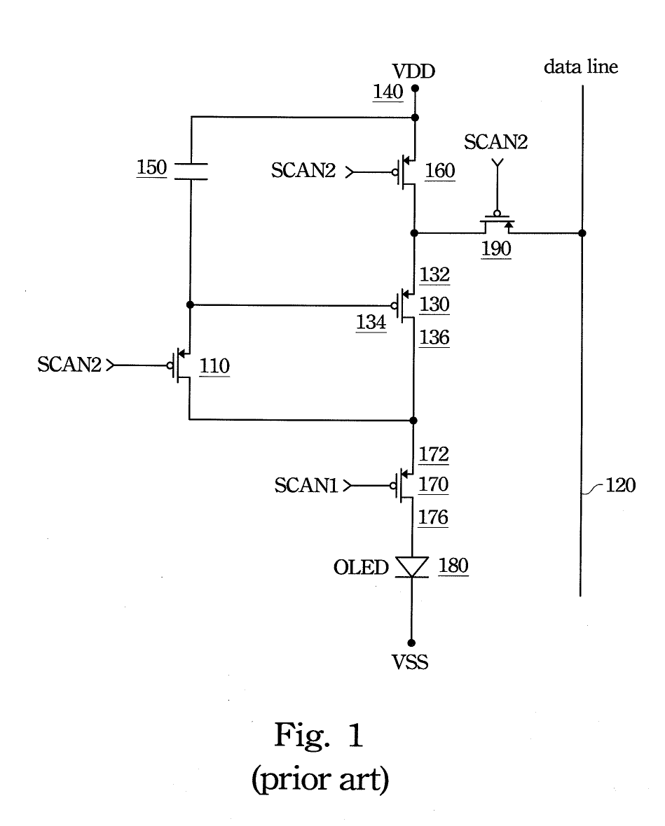

Compared with the prior art in FIG. 1, the transistors of this embodiment are decreased to be four transistors (switches 270, 210, 290 and the driving transistor 230), and the aperture ratio of each pixel circuit is increased thereby.

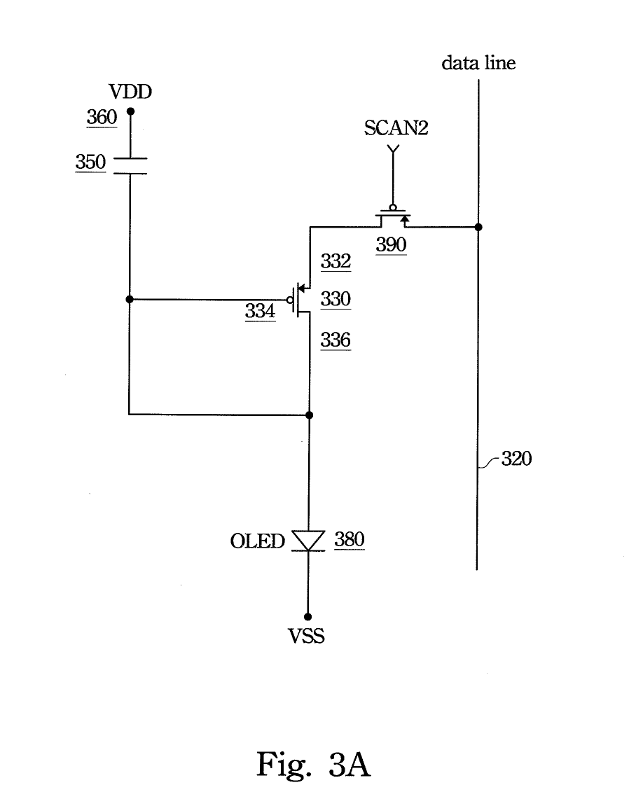

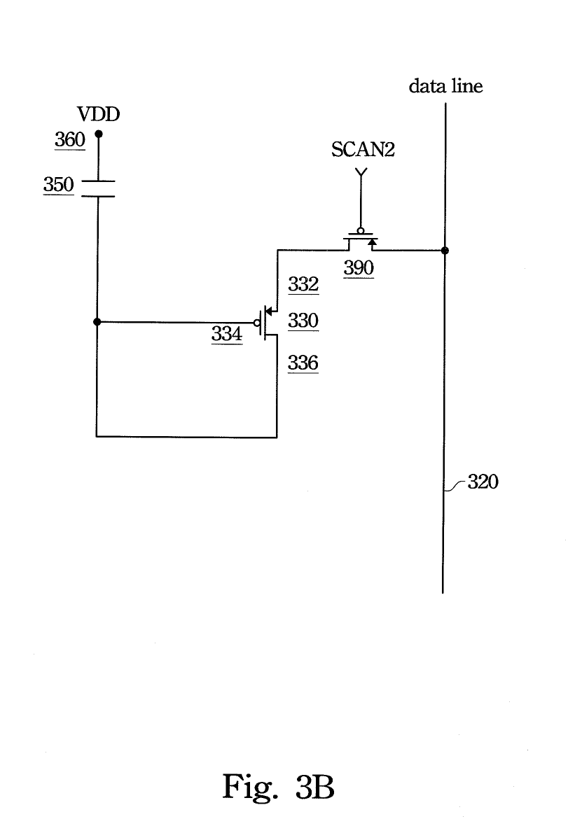

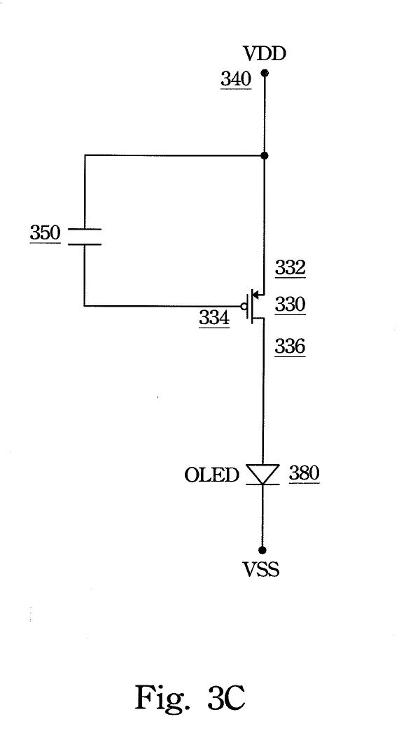

FIGS. 3A˜3C respectively shows the organic light emitting diode pixel circuit during the precharge, programming and display stages according to the embodiment of the invention. The pixel circuit operates during the precharge stage, the programming stage, and the display stage sequentially. The pixel circuit has an organic light emitting diode 380, a driving transistor 330, and a capacitor 350. The driving transistor 330 has a first source/drain 336 coupling to the organic light emitting diode 380 during the precharge (FIG. 3A) and display (FIG. 3C) stages, and decoupling to the organic light emitting diode 380 during the programming stage (FIG. 3B). The driving transistor 330 has a second source/drain 332 coupling to a first power source terminal 340 during the display stage. The capacitor 350 couples to the first source/drain 336 during the precharge and programming stages, and decoupling to the first source/drain 336 only during the display stage. The capacitor 350 also couples between a gate 334 of the driving transistor 330 and a second power source terminal 360.

The pixel circuit has a switch 390 coupling between a data line 320 and the second source/drain 332 during the precharge and programming stages. Therefore, during the precharge and programming stages, the data signals from the data line 320 are transmitted to the pixel circuit. The switch 390 can be implemented by a transistor.

In other words, the organic light emitting diode 380 has a cathode coupled to a first power terminal 340. The capacitor 350 is coupled between a gate of the driving transistor 330 and a second power source terminal 360. A first source/drain 336 of the driving transistor 330 is coupled to an anode of the organic light emitting diode 380 and a second source/drain 332 of the driving transistor 330 is coupled to receive a data signal during a precharge period (FIG. 3A). The first source/drain 336 of the driving transistor 330 is decoupled from the anode of the organic light emitting diode 380 and the second source/drain 332 of the driving transistor 330 is coupled to receive the data signal during a programming period (FIG. 3B). The first source/drain 336 of the driving transistor 330 is coupled to the anode of the organic light emitting diode 380 and the second source/drain 332 of the driving transistor 330 is coupled to the second power terminal 360 during a display period (FIG. 3C).

The voltages of the first power source terminal 340 and the second power source terminal 360 are provided by a gate driver. The first power source terminal 340 (i.e. the second source/drain 332 of the driving transistor 330) is floating during the precharge and programming stages, and the voltage of the second power source terminal 260 is a fixed voltage. Therefore, the data signals can be written into the pixel circuit more easily during the precharge and programming stages.

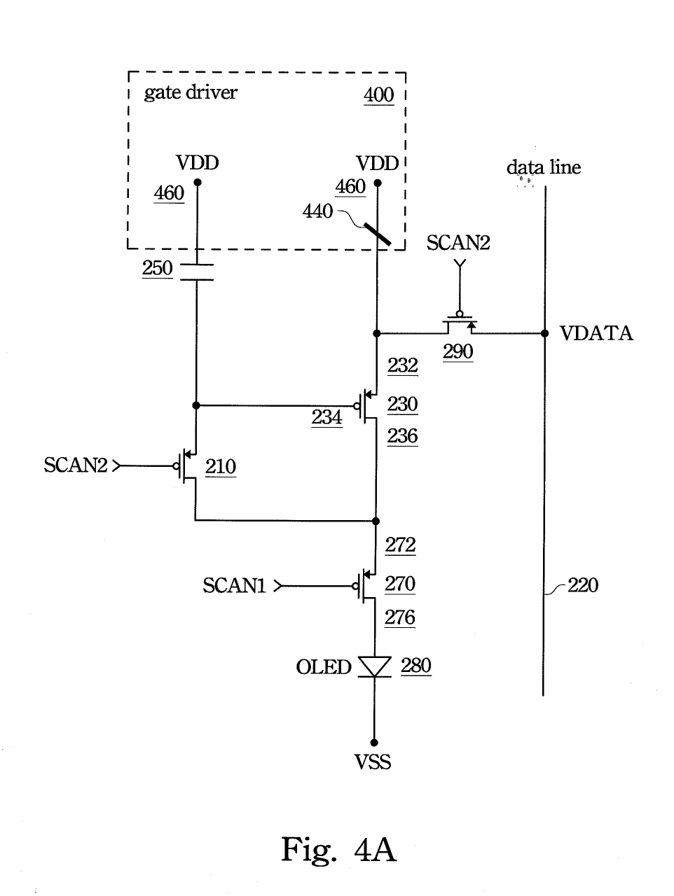

FIG. 4A shows an organic light emitting diode pixel circuit according to another embodiment of the invention. The pixel circuit has an organic light emitting diode 280, a first switch 270, a driving transistor 230, a capacitor 250, and a switch unit. The first switch 270 has a first end 276 coupled to the light emitting diode 280, wherein the first switch 270 is controlled by a first scan signal. The driving transistor 230 has a source/drain 236 coupling to a second end 272 of the first switch 270. The capacitor 250 couples between a gate 234 of the driving transistor 230 and a power source terminal 460. The switch unit has switches 210 and 440. When a second scan signal is asserted, the switches 210 and 440 respectively couple the second end 272 of the first switch 270 to the capacitor 250, couple the gate 234 and the source/drain 236 of the driving transistor 230 together, and couple a source/drain 232 of the driving transistor 230 to the power source terminal 460.

The difference between the embodiments of FIG. 2A and FIG. 4A is that the switch unit in FIG. 4A has a power switch 440 coupled between the source/drain 232 of the driving transistor 230 and the power source terminal 460. The power switch is controlled by the second scan signal. Therefore, the power source terminal 460 is floating when the second scan signal is de-asserted.

The power switch 440 can be configured in the gate driver 400. Therefore, compared with the prior art of FIG. 1, many pixel circuits can share the same power switch 440.

By the description above, the embodiments of this invention with the function voltage compensation does not doesn't need an extra reset signal. Otherwise, by these kinds of designs and operation, the pixel circuit can have higher aperture ratio.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel circuit, comprising:
a light emitting diode;
a first switch with a first end coupled to the light emitting diode, wherein the first switch is controlled by a first scan signal;
a driving transistor with source/drains respectively coupling to a first power source terminal and a second end of the first switch;
a capacitor coupling between a gate of the driving transistor and a second power source terminal; and
a second switch, when a second scan signal is asserted, respectively coupling the second end of the first switch to the capacitor, and coupling the gate and the source/drain of the driving transistor together.

2. The pixel circuit as claimed in claim 1, further comprising a third switch controlled by the second scan signal to couple between a data line and the source/drain.

3. The pixel circuit as claimed in claim 1, wherein voltages of the first power source terminal and the second power source terminal are provided by a gate driver.

4. The pixel circuit as claimed in claim 2, wherein the first power source terminal is floating when the third switch is turned on.

5. The pixel circuit as claimed in claim 1, wherein voltage of the second power source terminal is a fixed voltage.

6. The pixel circuit as claimed in claim 1, wherein the first switch, the second switch and the third switch are transistors.

7. A pixel circuit, comprising:
a driving transistor;
a light emitting diode having a cathode coupled to a first power terminal; and
a capacitor between a gate of the driving transistor and a second power source terminal;
wherein a first source/drain of the driving transistor is coupled to an anode of the light emitting diode and a second source/drain of the driving transistor is coupled to receive a data signal during a precharge period, the first source/drain of the driving transistor is decoupled from the anode of the light emitting diode and the second source/drain of the driving transistor is coupled to receive the data signal during a programming period, and the first source/drain of the driving transistor is coupled to the anode of the light emitting diode and the second source/drain of the driving transistor is coupled to the second power terminal during a display period.

8. The pixel circuit as claimed in claim 7, further comprising a switch coupling between a data line and the second source/drain during the precharge and programming stages.

9. The pixel circuit as claimed in claim 7, wherein voltages of the first power source terminal and the second power source terminal are provided by a gate driver.

10. The pixel circuit as claimed in claim 8, wherein the first power source terminal is floating when the switch is turned on.

11. The pixel circuit as claimed in claim 8, wherein the switch is a transistor.

12. A pixel circuit, comprising:
an organic light emitting diode;
a first switch having a first end coupled to the light emitting diode, wherein the first switch is controlled by a first scan signal;
a driving transistor having a source/drain coupling to a second end of the first switch;
a capacitor coupling between a gate of the driving transistor and a power source terminal;
a switch unit, when a second scan signal is asserted, respectively coupling the second end of the first switch to the capacitor, coupling the gate and the source/drain of the driving transistor together, and coupling a source/drain of the driving transistor to the power source terminal.

13. The pixel circuit as claimed in claim 12, further comprising a second switch controlled by the second scan signal to couple between a data line and the source/drain.

14. The pixel circuit as claimed in claim 12, wherein voltage of the power source terminal is provided by a gate driver.

15. The pixel circuit as claimed in claim 12, wherein the switch unit comprises a power switch coupled between the source/drain of the driving transistor and the power source terminal.

16. The pixel circuit as claimed in claim 15, wherein the power switch is controlled by the second scan signal.

17. The pixel circuit as claimed in claim 16, wherein the power switch is configured in the gate driver.

18. The pixel circuit as claimed in claim 12, wherein the first switch, the second switch and the power switch are transistors.
